(19) United States
(12) Patent Application Publication
(10) Pub. No.: US 2026/0134088 A1
(43) Pub. Date: May 14, 2026

(54) AUTONOMOUS SYSTEM TREATY, NEGOTIATION, AND ARBITRATION PROTOCOL

(71) Applicant: George William Bickerstaff, III, Greenwich, CT (US)

(72) Inventor: George William Bickerstaff, III, Greenwich, CT (US)

(21) Appl. No.: 19/443,760

(22) Filed: Jan. 8, 2026

(51) Int. Cl. G06F 21/54

(52) U.S. Cl. CPC G06F 21/54; G06F 2221/034

(57) ABSTRACT

An autonomous system treaty, negotiation, and arbitration protocol is disclosed that enables autonomous systems to negotiate operational constraints, resolve conflicts, and enforce agreements without centralized control. The protocol provides deterministic arbitration, escalation mechanisms, and execution-time enforcement, enabling scalable and governable interaction among distributed autonomous systems.

### TECHNICAL FIELD

The present invention relates to autonomous and artificial intelligence systems and, more particularly, to systems and methods that enable autonomous systems to negotiate, arbitrate, and enforce operational constraints, policies, and agreements with other autonomous systems.

### BACKGROUND

As autonomous systems increasingly interact with other autonomous systems across organizational, jurisdictional, and functional boundaries, conflicts between objectives, constraints, and policies become inevitable. Such conflicts may arise between independently developed systems, between systems operated by different entities, or between systems subject to differing regulatory or operational requirements.

Existing coordination approaches rely on static configurations, centralized control, or human-mediated negotiation, which are insufficient for dynamic, real-time interactions between autonomous systems operating at machine speed. The absence of a technical framework for autonomous negotiation and arbitration limits scalability, increases systemic risk, and impedes deployment of distributed autonomous ecosystems. There is therefore a need for a technical protocol that enables autonomous systems to negotiate constraints, resolve conflicts, and enforce agreements in a deterministic, auditable, and governable manner.

### SUMMARY OF THE INVENTION

The invention provides an autonomous system treaty, negotiation, and arbitration protocol that enables autonomous systems to negotiate operational policies, resolve conflicts between objectives, and enforce negotiated agreements. The protocol supports dynamic negotiation, conflict detection, arbitration, escalation, and enforcement without requiring centralized control.

The system generates machine-verifiable agreement records, supports human escalation when required, and enforces negotiated outcomes at execution time. By providing a standardized framework for autonomous negotiation and arbitration, the invention enables scalable, interoperable, and governable autonomous system interactions across distributed environments.

### Definitions (Alphabetical)

Agreement Record: A machine-verifiable representation of negotiated constraints or policies.
Arbitration Engine: A component that resolves conflicts between autonomous systems.
Conflict condition: a detected incompatibility between objectives or constraints.
Escalation Trigger: A condition that routes a conflict to human or external resolution.
Negotiation Context: Information defining the scope and conditions of a negotiation.
Negotiation Protocol: A defined sequence of message exchanges between autonomous systems.
Operational Constraint: A limitation governing autonomous system behavior.
Policy Proposal: A proposed set of constraints or terms submitted during negotiation.
Treaty State: The current status of a negotiated agreement.
Treaty Store: A repository for storing agreement records.

### BRIEF DESCRIPTION OF THE DRAWINGS

FIG. 1 illustrates autonomous policy negotiation architecture.

FIG. 2 illustrates conflict detection and arbitration.

FIG. 3 illustrates agreement enforcement mechanisms.

FIG. 4 illustrates escalation and override pathways.

FIG. 5 illustrates agreement persistence and auditing.

### DETAILED DESCRIPTION OF THE INVENTION

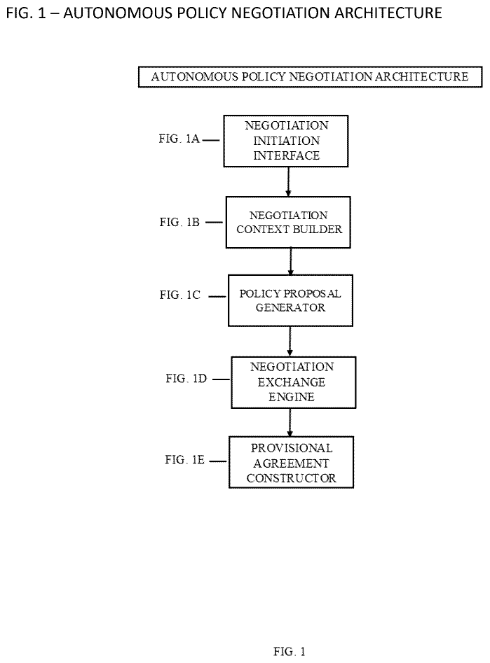

### FIG. 1—Autonomous Policy Negotiation Architecture

FIG. 1A illustrates a negotiation initiation interface through which an autonomous system initiates negotiation by submitting a policy proposal defining objectives, constraints, and desired outcomes.

FIG. 1B illustrates a negotiation context builder that assembles contextual information relevant to the negotiation, including system capabilities, environmental conditions, and applicable constraints.

FIG. 1C illustrates a policy proposal generator that produces machine-readable policy proposals based on system objectives and operational constraints.

FIG. 1D illustrates a negotiation exchange engine that exchanges policy proposals between autonomous systems using a defined negotiation protocol, with each exchange authenticated and logged.

FIG. 1E illustrates a provisional agreement constructor that combines converging proposals into a provisional agreement subject to validation.

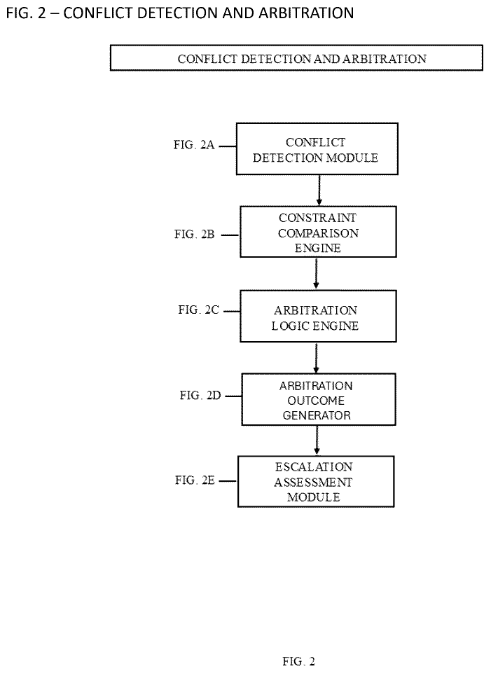

### FIG. 2—Conflict Detection and Arbitration

FIG. 2A illustrates a conflict detection module that evaluates incoming proposals for incompatibilities and classifies detected conflict conditions by severity.

FIG. 2B illustrates a constraint comparison engine that compares proposed constraints to identify overlapping, contradictory, or redundant terms.

FIG. 2C illustrates an arbitration logic engine that applies arbitration rules to resolve conflicts deterministically.

FIG. 2D illustrates an arbitration outcome generator that produces revised policy terms or rejection outcomes with associated justification.

FIG. 2E illustrates an escalation assessment module that evaluates escalation triggers when conflicts cannot be resolved autonomously.

### Example Autonomous System Treaty Negotiation and Arbitration Scenario

In one example embodiment, a first autonomous system and a second autonomous system operate within a shared environment requiring coordination of operational constraints. The first autonomous system submits a policy proposal through the negotiation initiation interface illustrated in FIG. 1A. A negotiation context is constructed by the negotiation context builder illustrated in FIG. 1B, establishing scope, system capabilities, and environmental conditions applicable to the negotiation.

Policy proposals are exchanged between the autonomous systems using the negotiation exchange engine illustrated in FIG. 1D in accordance with a negotiation protocol. During exchange, a conflict condition is detected by the conflict detection module illustrated in FIG. 2A due to incompatible operational constraints. The constraint comparison engine illustrated in FIG. 2B identifies contradictory terms and forwards the conflict to the arbitration logic engine illustrated in FIG. 2C.

The arbitration logic engine applies predefined arbitration rules to resolve the conflict and generates revised policy terms via the arbitration outcome generator illustrated in FIG. 2D. If the conflict cannot be resolved autonomously, an escalation trigger is evaluated by the escalation assessment module illustrated in FIG. 2E to determine whether human or external arbitration is required.

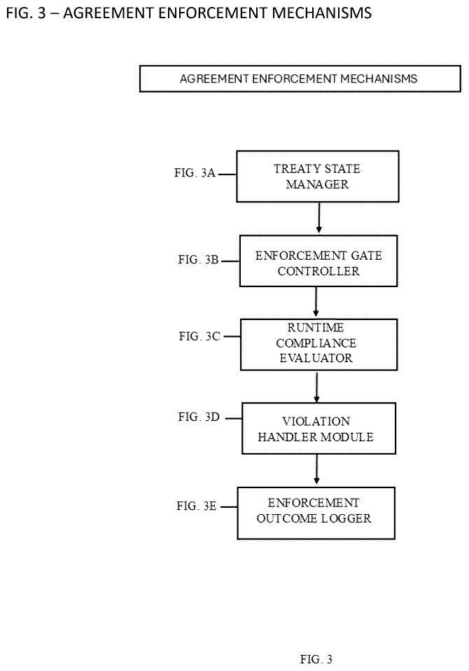

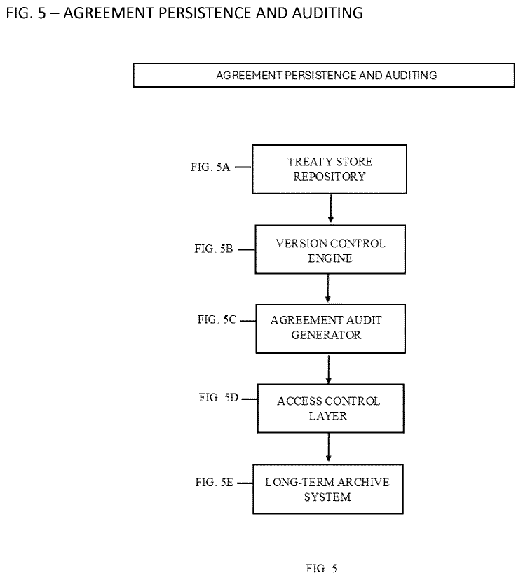

Upon resolution, a provisional agreement is validated and stored as an agreement record in the treaty store illustrated in FIG. 5A. The agreement transitions to an active treaty state managed by the treaty state manager illustrated in FIG. 3A. During subsequent operation, proposed actions by either autonomous system are evaluated against the negotiated agreement by the enforcement gate controller illustrated in FIG. 3B. Actions that violate the agreement are blocked, modified, or routed for renegotiation, and enforcement outcomes are logged for auditing.

This example is provided for illustrative purposes only, and the invention is not limited to the specific systems, negotiation terms, conflict conditions, or enforcement outcomes described.

### FIG. 3—Agreement Enforcement Mechanisms

FIG. 3A illustrates a treaty state manager that maintains the current treaty state of negotiated agreements and tracks valid state transitions.

FIG. 3B illustrates an enforcement gate controller that enforces agreements at execution time by evaluating proposed actions against treaty constraints.

FIG. 3C illustrates a runtime compliance evaluator that continuously monitors execution behavior for deviations from negotiated agreements.

FIG. 3D illustrates a violation handler module that triggers predefined responses, including execution termination or renegotiation.

FIG. 3E illustrates an enforcement outcome logger that records all enforcement actions and outcomes in tamper-resistant logs.

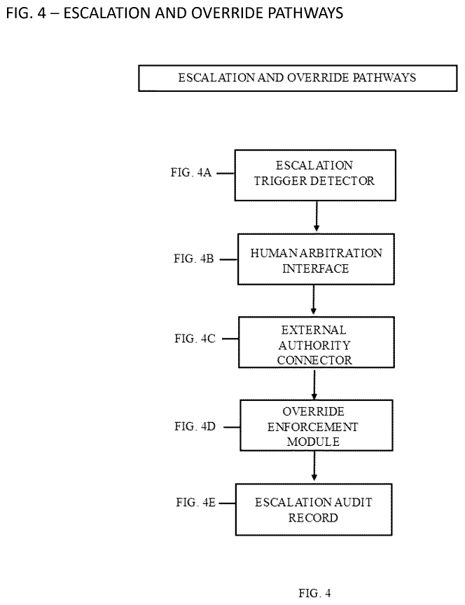

### FIG. 4—Escalation and Override Pathways

FIG. 4A illustrates an escalation trigger detector that automatically detects conditions requiring escalation.

FIG. 4B illustrates a human arbitration interface that presents escalated issues to human arbitrators with supporting context.

FIG. 4C illustrates an external authority connector that routes escalations to external authorities or contractual arbitration systems.

FIG. 4D illustrates an override enforcement module that enforces human or external arbitration decisions.

FIG. 4E illustrates an escalation audit record that archives escalation events, decisions, and outcomes.

### FIG. 5—Agreement Persistence and Auditing

FIG. 5A illustrates a treaty store repository that securely stores agreement records.

FIG. 5B illustrates a version control engine that maintains agreement versions and preserves historical states.

FIG. 5C illustrates an agreement audit generator that produces audit artifacts demonstrating negotiation and enforcement history.

FIG. 5D illustrates an access control layer that enforces policy-based access to agreement data.

FIG. 5E illustrates a long-term archive system that preserves agreements and audits for dispute resolution and compliance.

1. An autonomous system negotiation protocol comprising:
a negotiation exchange engine configured to exchange policy proposals between autonomous systems;
an arbitration engine configured to resolve conflicts between proposed constraints; and
an enforcement gate configured to enforce negotiated agreements at execution time.

2. A method for autonomous negotiation and arbitration comprising:
exchanging policy proposals between autonomous systems;
detecting conflicts between proposed policies;
resolving conflicts using arbitration logic; and
enforcing negotiated outcomes during execution.

3. A non-transitory computer-readable medium storing instructions that cause autonomous systems to negotiate, arbitrate, and enforce operational agreements. 4. The protocol of claim 1, wherein negotiation occurs dynamically during operation.

5. The method of claim 2, wherein unresolved conflicts are escalated to human arbitration.

6. The protocol of claim 1, wherein agreements are enforced prior to execution commitment.

7. The method of claim 2, wherein arbitration outcomes are logged immutably.

8. The protocol of claim 1, wherein negotiation context constrains proposal scope.

9. The computer-readable medium of claim 3, wherein enforcement violations trigger renegotiation.

10. The protocol of claim 1, wherein agreement records are machine-verifiable.
